(19) United States
(12) Patent Application Publication
(10) Pub. No.: US 2012/0253995 A1
(43) Pub. Date: Oct. 4, 2012

(54) SYSTEM AND METHOD FOR MERCHANDISE INVENTORY MANAGEMENT TO MAXIMIZE GROSS MARGIN

(76) Inventors: AMIT BOOB, (US); Ajesh Kapoor, (US); Jiefeng Xu, (US); Dalbir Arora, (US)

(21) Appl. No.: 13/076,504

(22) Filed: Mar. 31, 2011

(51) Int. Cl. G06Q 10/00

(52) U.S. Cl. 705/28

(57) ABSTRACT

A system and method for merchandise inventory management to maximize gross margin is disclosed. In one embodiment, the method includes modeling inventory to maximize gross margin as a function of replenishment of each item in each location based on optimum customer service level. Further, a desired customer service level range is determined. Furthermore, a safety stock level is computed for each customer service level in the determined customer service level range based on supplier information and forecasted future demand. In addition, replenishment quantity is computed for each customer service level in the determined customer service level range based on the computed safety stock level, lost sales information, markdown costs, and economic order quantity. Moreover, gross margin is computed for each customer service level in the determined customer service level range based on the computed replenishment quantity, markdown schedule and other financial information.

### BACKGROUND

Companies today have to manage and optimize their supply chain ever more aggressively because they are experiencing increasingly stronger competition. For example, retail industry uses gross margin as an important measure to evaluate organizational performance. Gross margin is generally defined as the revenue less the cost of sales. To maximize gross margin, companies have to minimize cost of sales, which includes manageable business costs, such as inventory cost and markdown cost. Further, companies have to maintain certain customer service level to stay competitive and not lose loyal customers. However, customer service level has a great impact on inventory cost and thus on the gross margin. Since the customer service level as well as the markdown activities can directly impact retailers' financial bottom-line, management teams are always challenged to find an optimal customer service level that incorporates the complete lifecycle of a product including markdown activities.

To survive in today's competitive environment, retailers have to constantly seek a way to increase revenue and/or reduce cost. Controlling inventory can result in dual benefits of reducing holding costs as well as reducing risks of obsolescence or markdowns. Therefore, controlling inventory has become one of the top priorities for companies. Companies have long tradition to implement inventory optimization models to reduce the inventory costs. In traditional inventory optimization models, customer service level is defined as an input factor. However, with the increasing cost pressure, the decision makers have been forced to fully optimize the cost controls and to use advancement in computing power and modeling capability for such purposes. It is common for industries to explore tradeoffs between customer service level and inventory cost, and then to select an optimal customer service level for individual product/item subject to certain business constraints. Further, retailers are also using markdown optimization as an important tool to reduce end-of-season or end-of-life merchandise. Existing inventory optimization solutions seem to concentrate on maximizing gross margin based on strategies to minimize inventory carrying cost or change the price of the product (discounting) and appear to be partial and not complete.

### SUMMARY

A system and method for merchandise inventory management to maximize gross margin is disclosed. In accordance with one aspect of the present invention, inventory is modeled to maximize gross margin as a function of the replenishment of each item in each location based on an optimum customer service level. Further, a desired customer service level range is determined for each item in each location based on parameters, such as sales history, economic order quantity, markdown information and forecasted future demand. Furthermore, a safety stock level is computed for each item in each location for each customer service level in the determined customer service level range using supplier lead time information and forecasted future demand. In addition, a replenishment quantity is computed for each item in each location for each customer service level in the determined customer service level range based on the computed safety stock level, the forecast demand pattern and the economic order quantity. Moreover, the gross margin is computed for each item in each location for each customer service level in the determined customer service level range based on the computed replenishment quantity, lost sales, the inventory carrying costs, markdown schedule and other financial information.

Further in this embodiment, an optimum customer service level is determined for each item in each location based on the computed gross margin for each item in each location in the determined customer service level range to maximize the gross margin. Furthermore, a required inventory level is determined for each item in each location based on the determined optimum customer service level and demand pattern to maximize the gross margin.

According to another aspect of the present subject matter, a non-transitory computer-readable storage medium for merchandise inventory management to maximize gross margin, having instructions that, when executed by a computing device causes the computing device to perform the method described above.

According to yet another aspect of the present subject matter, system for merchandise inventory management system to maximize gross margin includes a processor and memory coupled to the processor. Further, the memory includes an inventory management module. In one embodiment, the inventory management module includes instructions to model inventory to maximize the gross margin as a function of replenishment of merchandise that is based on the optimum customer service level.

### BRIEF DESCRIPTION OF THE DRAWINGS

Various embodiments are described herein with reference to the drawings, wherein:

FIG. 1 is a flowchart illustrating a method for merchandise inventory management to maximize gross margin, according to an embodiment of the invention;

FIG. 2 is another flowchart illustrating a method, according to an embodiment of the invention;

FIG. 3 is yet another flowchart illustrating a method, according to an embodiment of the invention;

FIG. 4 is yet another flowchart illustrating a method, according to an embodiment of the invention;

FIG. 5 is another flowchart illustrating a method, according to an embodiment of the invention;

FIG. 6 is another flowchart illustrating a method, according to an embodiment of the invention;

FIG. 7 is another flowchart illustrating a method, according to an embodiment of the invention;

FIG. 8 is another flowchart illustrating a method, according to an embodiment of the invention;

FIG. 9 is a block diagram illustrating merchandise inventory management system, according to an embodiment of the invention and an environment in which methods, such as those shown in FIG. 1 can operate; and

FIG. 10 illustrates a block diagram of a data processing system in which any of the embodiments disclosed herein may be performed, according to an embodiment of the invention.

The drawings described herein are for illustration purposes only and are not intended to limit the scope of the present disclosure in any way.

### DETAILED DESCRIPTION

A system and method for merchandise inventory management to maximize gross margin is disclosed. In the following detailed description of the embodiments of the present subject matter, reference is made to the accompanying drawings that form a part hereof, and in which are shown by way of illustration specific embodiments in which the present subject matter may be practiced. These embodiments are described in sufficient detail to enable those skilled in the art to practice the present subject matter, and it is to be understood that other embodiments may be utilized and that changes may be made without departing from the scope of the present subject matter. The following detailed description is, therefore, not to be taken in a limiting sense, and the scope of the present subject matter is defined by the appended claims.

The term “customer service level” refers to a percentage that is based on expected likelihood of an item getting purchased by customers and the item is not out of stock and/or the item is available for purchase by the customer during a planning horizon.

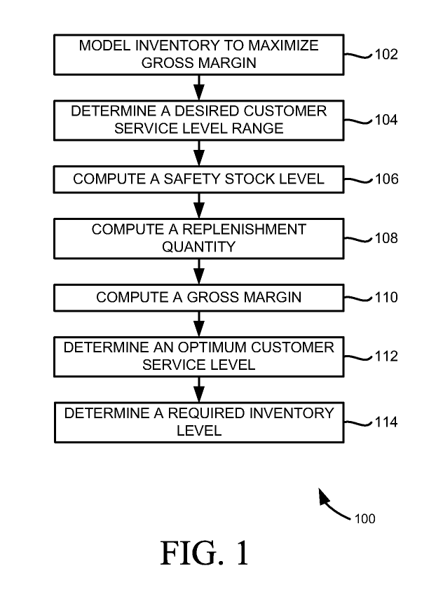

FIG. 1 is a flowchart 100 illustrating a method for merchandise inventory management to maximize gross margin, according to an embodiment of the invention. At block 102, inventory is modeled to maximize the gross margin as a function of replenishment of merchandise that is based on an optimum customer service level. Further, the optimum service level includes assumed values for at least inventory carrying costs, lost sales costs and markdown costs. Furthermore, the inventory is modeled to maximize gross margin as a function of the replenishment for each item in each location based on the optimum customer service level. Exemplary location includes a retail store and the like.

At block 104, a desired customer service level range is determined for each item in each location based on parameters, such as sales history, economic order quantity (EOQ), markdown information and forecasted future demand. At block 106, a safety stock level is computed for each item in each location for each customer service level in the determined customer service level range using supplier lead time information and the forecasted future demand. At block 108, a replenishment quantity is computed for each item in each location for each customer service level in the determined customer service level range based on the computed safety stock level, the forecast demand pattern, and the EOQ. At block 110, a gross margin is computed for each item in each location for each customer service level in the determined customer service level range based on the computed replenishment quantity, lost sales, the inventory carrying costs, markdown schedule and other financial information.

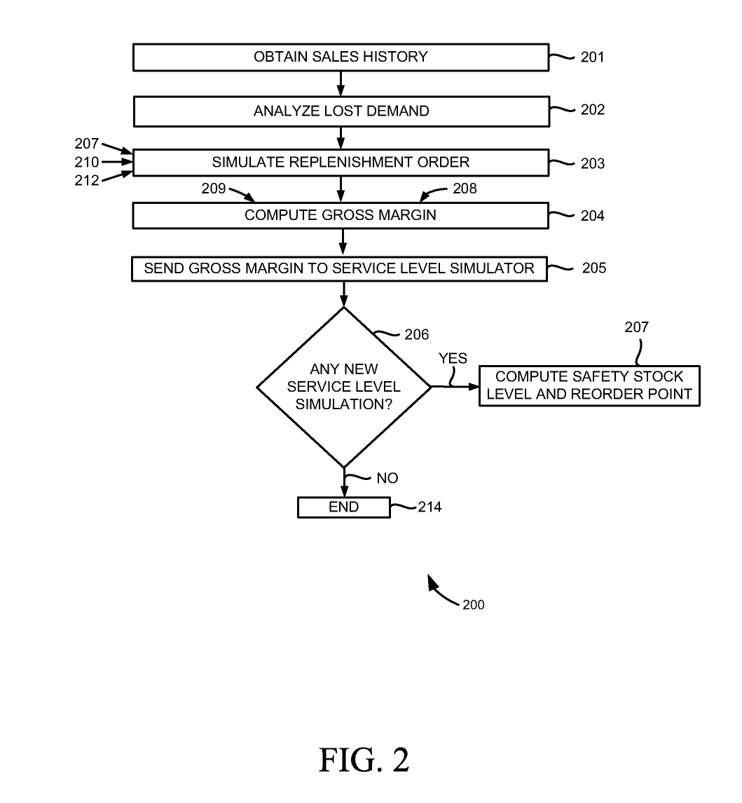

At block 112, an optimum customer service level is determined for each item in each location based on the computed gross margin for each item in each location in the determined customer service level range to maximize the gross margin. At block 114, a required inventory level is determined for each item in each location based on the determined optimum customer service level and parameters, such as order lead time, delivery schedule, demand pattern and the computed replenishment order quantity to maximize the gross margin. The methods of merchandise inventory management using different parameters are explained in more detail with reference to FIGS. 2 to 8.

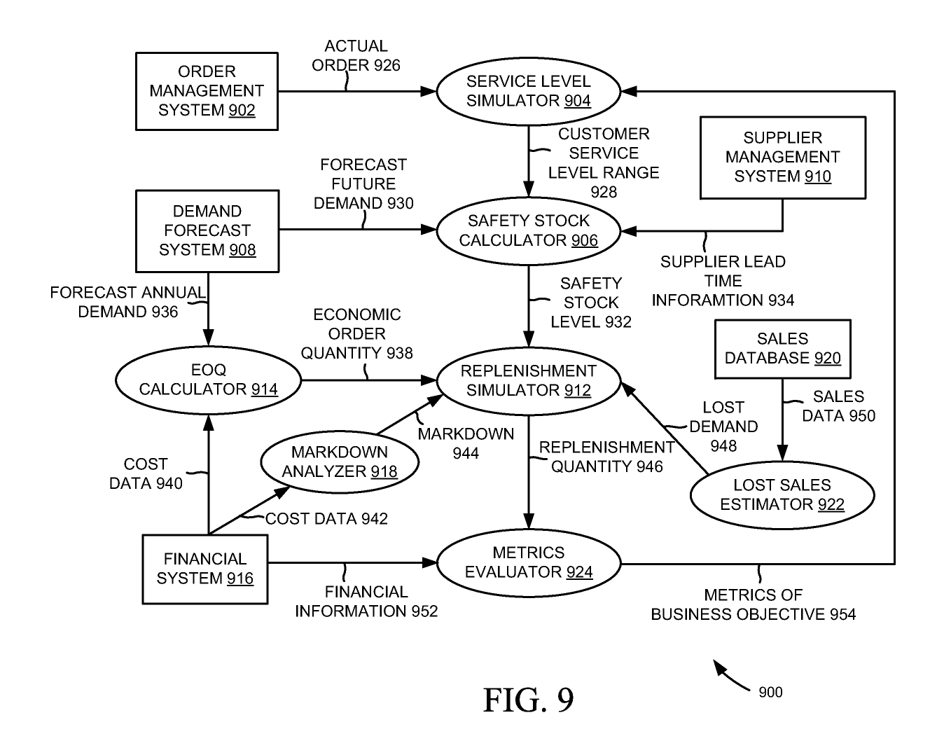

Referring now to FIG. 2, another flowchart 200 illustrates a method, according to an embodiment of the invention. At block 201, the sales history is obtained. In this embodiment, the sales history is obtained from an external data source. This is explained in more detail with reference to FIG. 9. At block 202, lost demand is analyzed. Further in this embodiment, the lost demand is analyzed based on the sales history obtained in the block 201 and end of day inventory for a day ‘t’. Furthermore in this embodiment, it is determined whether the day ‘t’ is a stock-out day or a non-stock-out day. A stock-out day is a day when end of day inventory is zero and a non-stock-out day is a day when the end of day inventory is not zero.

In addition in this embodiment, if the day ‘t’ is a non-stock-out day, then the lost demand is zero. Moreover in this embodiment, if the day ‘t’ is a stock-out day, then the lost demand is analyzed based on a would-be demand and units of inventory sold. The would-be demand is estimated for the day ‘t’ using an average of a demand on the most immediate non-stock-out day before the day ‘t’, a demand on the most immediate non-stock-out day after the day ‘t’, a demand on the most immediate non-stock-out day in the same week before the day ‘t’ and a demand on the most immediate non-stock-out day in the same week after the day ‘t’. Also, if the units of inventory sold on the day ‘t’ is more than the estimated would-be demand, then the lost demand is zero. Further, if the units of inventory sold on the day ‘t’ is less than the estimated would-be demand, then the lost demand is computed using an equation:

lost demand=would-be demand−units of inventory sold (1)

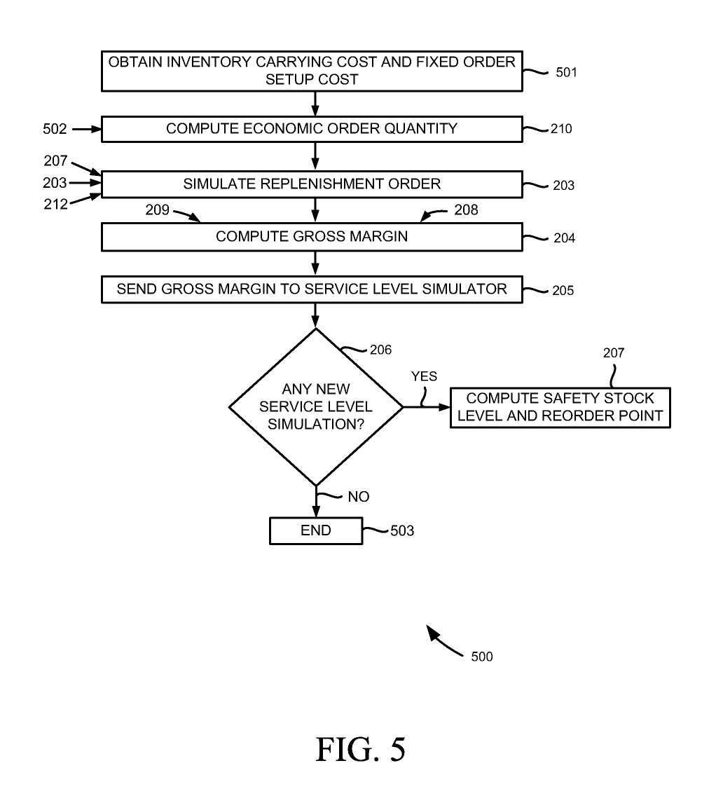

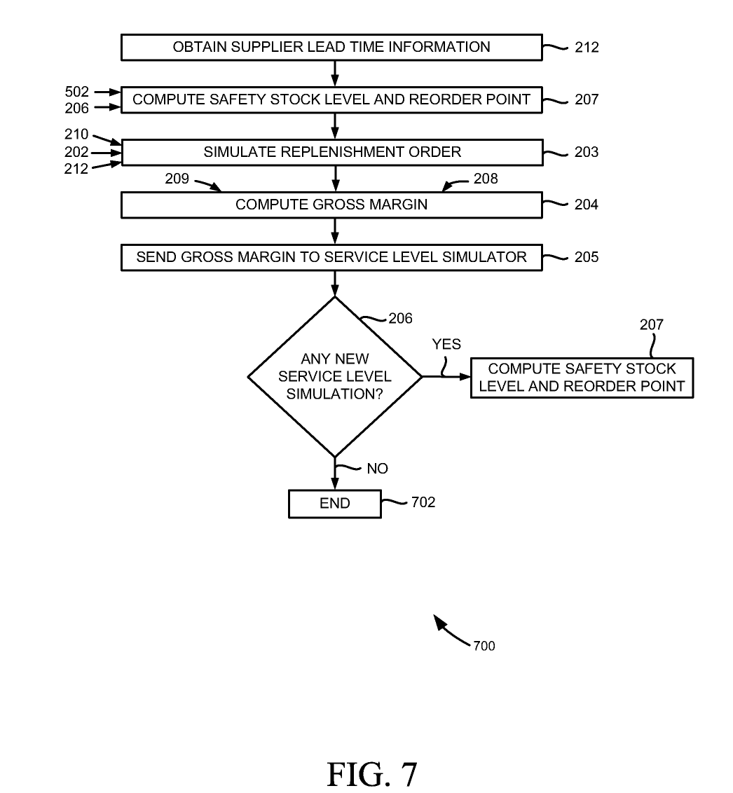

At block 203, the replenishment order is simulated. In this embodiment, the replenishment order is computed based parameters, such as a safety stock level which is computed as explained in detail with reference to block 207 in FIG. 2, an EOQ which is computed as explained in detail with reference to a block 210 in FIG. 5, a supplier lead time information which is obtained as explained in detail with reference to a block 212 in FIG. 7, a reorder point, an average markdown cost, an initial inventory, the sales history obtained at the block 201, as shown in FIG. 2 and the lost demand estimated at the block 202, as shown in FIG. 2. Further in this embodiment, a true customer demand is obtained by combining the units of inventory sold and the estimated lost demand. Furthermore in this embodiment, the end of day inventory for the day ‘t’ is updated as:

End Of Day Inventory (t)=End Of Day Inventory (t−1)−min (True Customer Demand (t), End Of Day Inventory (t−1))+Shipment Received (t) (2)

wherein,

End Of Day Inventory (t) is the inventory available at the end of the day ‘t’ at the location;

End Of Day Inventory (t−1) is the inventory available on the most immediate day before the day ‘t’ at the location;

True Customer Demand (t) is the sum of units of inventory sold and the estimated lost demand; and

Shipment Received (t) is units of items received in a retail store from an upstream location or a facility. Exemplary upstream location or facility includes distribution centers, warehouses and the like. The units of items are received due to the replenishment orders or other planning activities on the day ‘t’. Further, the Shipment Received (t) can also include the units of items received from other stores (also referred to as store-to-store transfer).

In addition in this embodiment, if the True Customer Demand (t) is greater than the End Of Day Inventory (t−1), then the lost sales is computed. Also, On Order (t) is updated using an equation:

On Order (t)=On Order (t−1)−Shipment Received (t) (3)

wherein,

On Order (t) is an unit of replenishment order submitted and confirmed, but has not been received at the end of day ‘t’;

On Order (t−1) is the unit of replenishment order pending at the end of the most immediate day before the day ‘t’; and

Shipment Received (t) is the units of items received in the retail store from the upstream location or the facility.

Moreover in this embodiment, On Hand Inventory (t) is updated using an equation:

On Hand Inventory (t)=End Of Day Inventory (t)+On Order (t) (4)

wherein,

On Hand Inventory (t) is the total inventory that includes the physical inventory and the virtual inventory for which orders have been submitted and confirmed, but have not been received at the end of day ‘t’;

End Of Day Inventory (t) is the is the inventory available at the end of the day ‘t’ at the location; and

On Order (t) is the unit of replenishment orders submitted and confirmed, but have not been received at the end of day ‘t’.

Also in this embodiment, if a Reorder Point (t) is greater than the On Hand Inventory (t), then an order is submitted. The quantity of the order submitted is computed using an equation:

Order Quan (t)=max (EOQ_Order Quan, Reorder Point (t)−On Hand Inventory (t)) (5)

wherein,

Order Quan (t) is a quantity of the replenishment order submitted on the day ‘t’;

EOQ_Order Quan is the EOQ that optimizes the tradeoff between the one time ordering cost and the inventory carrying cost;

Reorder Point (t) is a threshold based on the future forecasted demand and the safety stock level that determines whether a replenishment order has to be submitted; and

On Hand Inventory (t) is the total inventory that includes the physical inventory and the virtual inventory.

In addition in this embodiment, if the Reorder Point (t) is not greater than the On Hand Inventory (t), then the Order Quan (t) is zero. Also, the On Order (t) is updated using an equation:

On Order (t)=On Order (t)+Order Quan (t) (6)

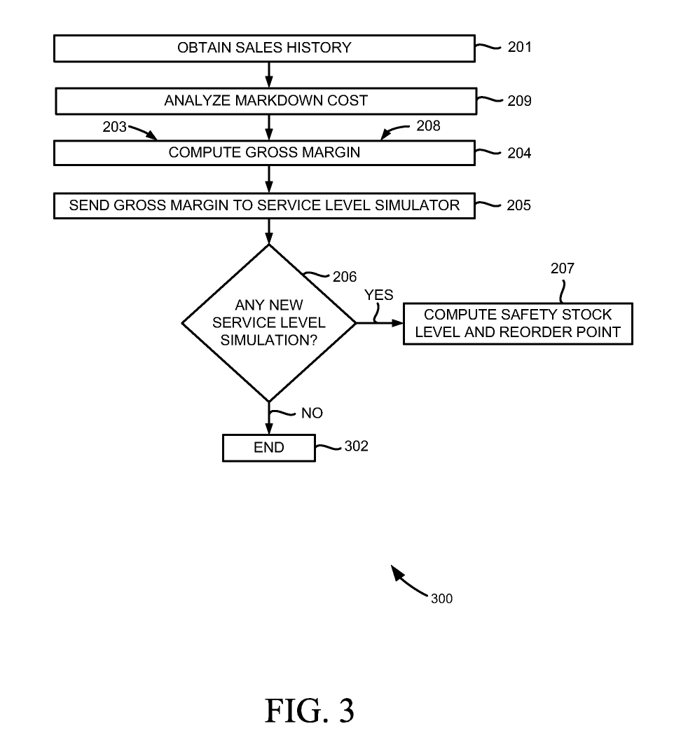

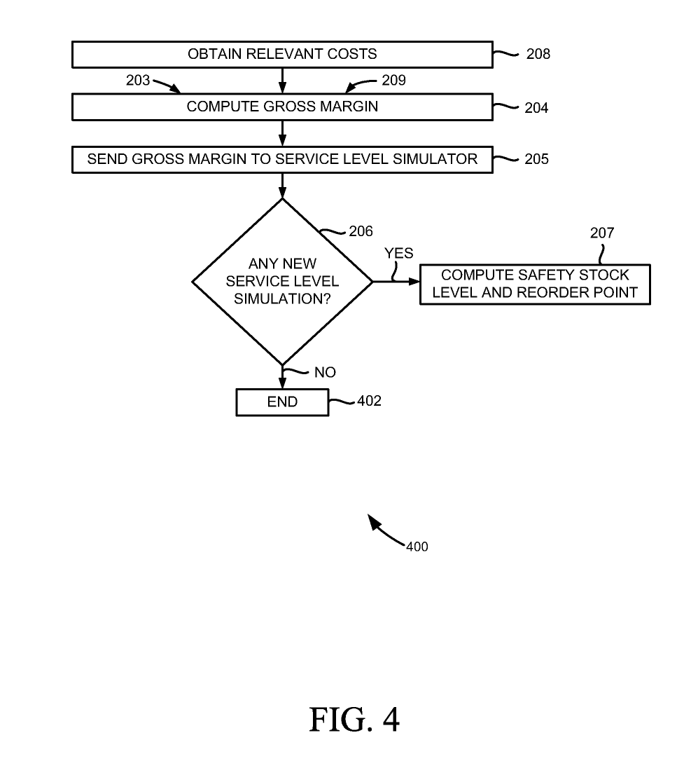

At block 204, the gross margin is computed. In this embodiment, the gross margin is computed based on parameters, such as a markdown cost which is computed as explained in detail with reference to a block 209 in FIG. 3, the relevant cost which is computed as explained in detail with reference to a block 208 in FIG. 4, a sales margin, the lost sales and an average markdown quantity. Further in this embodiment, for a given customer service level α, the gross margin is computed using an equation:

Gross Margin (α)=Sales Margin of Would-Be Demand (α)−Inventory Carrying Cost (α)−Sales Margin of Lost Demand (α)−Markdown Cost (α) (7)

wherein,

α is the given customer service level;

Gross Margin (α) is the gross margin based on the customer service level α;

Sales Margin of Would-Be demand (α) is the sales margin for the would-be demand, as shown in the equation (1), based on the customer service level α;

Inventory Carrying Cost (α) is an inventory carrying cost based on the customer service level α;

Sales Margin of Lost demand (α) is the sales margin for the lost demand, as shown in the equation (1), based on the customer service level α; and

Markdown Cost (α) is the markdown cost based on the customer service level α.

At block 205, the computed gross margin is sent to a service level simulator. In this embodiment, the service level simulator simulates the impact of various customer service levels. This is explained in more detail with reference to FIG. 9. At block 206, it is determined whether there is any new customer service level to be simulated. Further in this embodiment, the simulation includes selecting a value a from the customer service level range. The process of determining the customer service level range is explained in detail with reference to block 104 in FIG. 1. In addition in this embodiment, after simulation, a new value for α, i.e., α* is obtained using equation:

α*=arg max{Gross Margin(α)} (8)

Moreover in this embodiment, if there is a new customer service level, the safety stock level and the reorder point is computed at the block 207. The safety stock level is computed using an equation:

Safety Stock Level=z(Customer Service Level)*standard deviation of Forecast Demand (9)

wherein,

z (Customer Service Level) is a coefficient whose value is obtained from a probability of a normal distribution that does not exceed the customer service level. The reorder point is computed using an equation:

Reorder Point=Forecast Demand Over Lead Time+Safety Stock Level (10)

Also in this embodiment, the process is repeated from the block 203 until an optimal customer service level that maximizes the gross margin is obtained. If there is no new customer service level to be simulated at the block 206, the process ends at block 214.

Referring now to FIG. 3, yet another flowchart 300 illustrates a method, according to an embodiment of the invention. At block 201, the sales history is obtained. This is explained in more detail with reference to the block 201 in FIG. 2. At block 209, the markdown cost is analyzed. In this embodiment, the markdown cost is analyzed based on the obtained sales history at the block 201, a selling price and markdown events. Further in this embodiment, an average markdown selling price is computed based on the obtained sales history and the markdown events. Furthermore in this embodiment, an average regular selling price is computed using the obtained sales history. In addition in this embodiment, the average markdown cost is obtained using an equation:

Average markdown cost=average regular selling price−average markdown selling price (11)

At block 204, the gross margin is computed. In this embodiment, the gross margin is computed based on parameters, such as the replenishment order which is computed as explained in detail with reference to the block 203 in FIG. 2 and the relevant cost which is computed as explained in detail with reference to the block 208 in FIG. 4. Further, the computation of the gross margin using the equation (7) is explained in more detail with reference to the block 204 in FIG. 2.

At block 205, the computed gross margin is sent to the service level simulator. This is explained in more detail with reference to the block 205 in FIG. 2. At block 206, it is determined whether there is any new customer service level to be simulated. This is explained in more detail with reference to the block 206 in FIG. 2. Further in this embodiment, if there is a new customer service level, the safety stock level and the reorder point is computed at the block 207. Furthermore, the computation of the safety stock level and the reorder point using the equations (9) and (10) are explained in more detail with reference to the block 207 in FIG. 2. In addition in this embodiment, if there is no new customer service level to be simulated, the process ends at block 302.

Referring now to FIG. 4, yet another flowchart 400 illustrates a method, according to an embodiment of the invention. At block 208, relevant costs are obtained. In this embodiment, the relevant costs are obtained from an external data source. This is explained in more detail with reference to FIG. 9. Further in this embodiment, the relevant costs include inventory carrying cost per stock-keeping unit (SKU) per day, an order setup cost, a selling margin and other relevant financial costs.

At block 204, the gross margin is computed. In this embodiment, the gross margin is computed based on parameters, such as the replenishment order which is computed as explained in detail with reference to the block 203 in FIG. 2 and the markdown cost which is computed as explained in detail with reference to the block 209 in FIG. 3. Further, the computation of the gross margin using the equation (7) is explained in more detail with reference to the block 204 in FIG. 2.

At block 205, the computed gross margin is sent to the service level simulator. This is explained in more detail with reference to FIG. 2. At block 206, it is determined whether there is any new customer service level to be simulated. This is explained in more detail with reference to the block 206 in FIG. 2. Further in this embodiment, if there is a new customer service level, the safety stock level and the reorder point is computed at the block 207. Furthermore, the computation of the safety stock level and the reorder point using the equations (9) and (10) are explained in more detail with reference to the block 207 in FIG. 2. In addition in this embodiment, if there is no new customer service level to be simulated, the process ends at block 402.

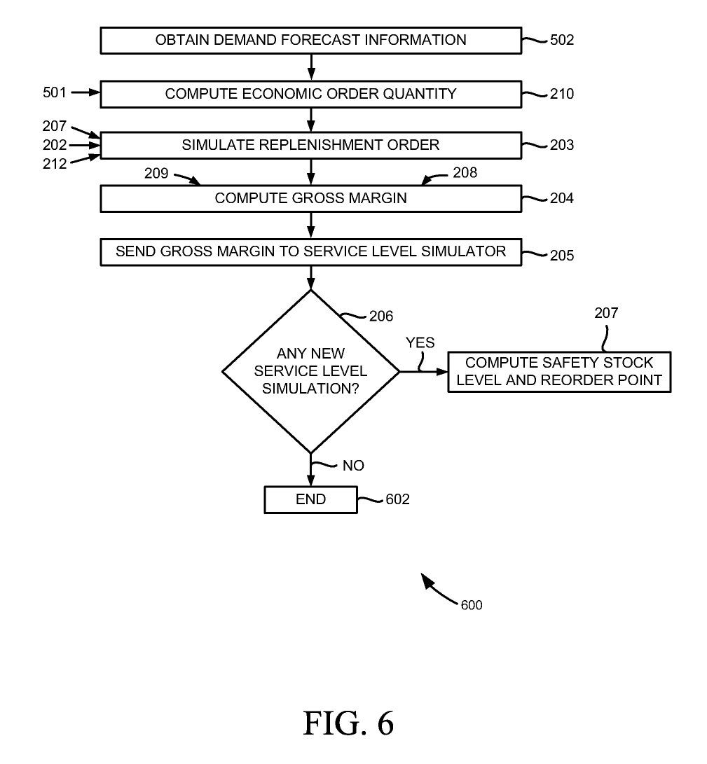

Referring now to FIG. 5, another flowchart 500 illustrates a method, according to an embodiment of the invention. At block 501, inventory carrying cost and fixed order setup cost are obtained. The inventory carrying cost and fixed order setup cost are obtained from an external data source. This is explained in more detail with reference to FIG. 9. Further in this embodiment, the inventory carrying cost includes inventory carrying cost per SKU per day. At block 210, the EOQ is computed. The EOQ is computed based on the inventory carrying cost per SKU per day, the fixed order setup cost and the demand forecast information which is obtained as explained in detail with reference to a block 502 in FIG. 6. Furthermore in this embodiment, the EOQ is obtained using an equation:

EOQ=Square Root (2*Annual Forecast Demand*Order Setup Cost/Annual Inventory Carrying Cost) (12)

At block 203, the replenishment order is simulated. The replenishment order is computed based parameters, such as the safety stock level which is computed as explained in detail with reference to the block 207 in FIG. 2, the replenishment order which is computed as explained in detail with reference to the block 203 in FIG. 2, and the supplier lead time information obtained as explained in detail with reference to the block 212 in FIG. 7. Furthermore, the computation of the replenishment order using the equations (2) to (6) are explained in more detail with reference to the block 203 in FIG. 2. At block 204, the gross margin is computed. This is explained in more detail with reference to the block 204 in FIG. 2.

At block 205, the computed gross margin is sent to the service level simulator. This is explained in more detail with reference to the block 205 in FIG. 2. At block 206, it is determined whether there is any new customer service level to be simulated. This is explained in more detail with reference to the block 206 in FIG. 2. Further, if there is a new customer service level, the safety stock level and the reorder point is computed at the block 207. Furthermore, the computation of the safety stock level and the reorder point using the equations (9) and (10) are explained in more detail with reference to the block 207 in FIG. 2. In addition, if there is no new customer service level to be simulated, the process ends at block 503.

Referring now to FIG. 6, another flowchart 600 illustrates a method, according to an embodiment of the invention. At block 502, the demand forecast information is obtained. In this embodiment, the demand forecast information is obtained from an external source. This is explained in more detail with reference to FIG. 9. At block 210, the EOQ is computed. The EOQ is computed based on the inventory carrying cost and the fixed order setup cost which is obtained as explained in detail with reference to the block 501 in FIG. 5. Furthermore, the computation of the EOQ using the equation (12) is explained in detail with reference to the block 210 in FIG. 5.

At block 203, the replenishment order is simulated. The replenishment order is computed based parameters, such as a safety stock level computed as explained in detail with reference to the block 207 in FIG. 2, the lost demand computed as explained in detail with reference to the block 202 in FIG. 2 and a supplier lead time information obtained as explained in detail with reference to the block 212 in FIG. 7. Furthermore, the computation of the replenishment order using the equations (2) to (6) are explained in more detail with reference to the block 203 in FIG. 2. At block 204, the gross margin is computed. This is explained in more detail with reference to the block 204 in FIG. 2.

At block 205, the computed gross margin is sent to the service level simulator. This is explained in more detail with reference to FIG. 2. At block 206, it is determined whether there is any new customer service level to be simulated. This is explained in more detail with reference to FIG. 2. Further, if there is a new customer service level, the safety stock level and the reorder point is computed at the block 207. Furthermore, the computation of the safety stock level and the reorder point using the equations (9) and (10) are explained in more detail with reference to the block 207 in FIG. 2. In addition, if there is no new customer service level to be simulated, the process ends at block 602.

Referring now to FIG. 7, another flowchart 700 illustrates a method, according to an embodiment of the invention. At block 212, supplier lead time information is obtained. In this embodiment, the supplier lead time information is obtained from an external source. This is explained in more detail with reference to FIG. 9. At block 207, the safety stock level and the reorder point is computed. This is explained in detail with reference to the block 207 in FIG. 2. In this embodiment, the safety stock level and the reorder point is computed based on the demand forecast information obtained as explained with reference to the block 502 in FIG. 6 and the output of the block 206 as explained with reference to the block 206 in FIG. 2.

At block 203, the replenishment order is simulated. The replenishment order is computed based parameters, such as the lost demand computed as explained in detail with reference to the block 202 in FIG. 2, the EOQ computed as explained in detail with reference to the block 210 in FIG. 5 and a supplier lead time information obtained as explained in detail with reference to the block 212 in FIG. 7. Further, the computation of the replenishment order using the equations (2) to (6) are explained in more detail with reference to the block 203 in FIG. 2. At block 204, the gross margin is computed. This is explained in more detail with reference to the block 204 in FIG. 2.

At block 205, the computed gross margin is sent to the service level simulator. This is explained in more detail with reference to FIG. 2. At block 206, it is determined whether there is any new customer service level to be simulated. This is explained in more detail with reference to the block 206 in FIG. 2. Further, if there is a new customer service level, the safety stock level and the reorder point is computed at the block 207. Furthermore, the computation of the safety stock level and the reorder point using the equations (9) and (10) are explained in more detail with reference to the block 207 in FIG. 2. In addition, if there is no new customer service level to be simulated, the process ends at block 702.

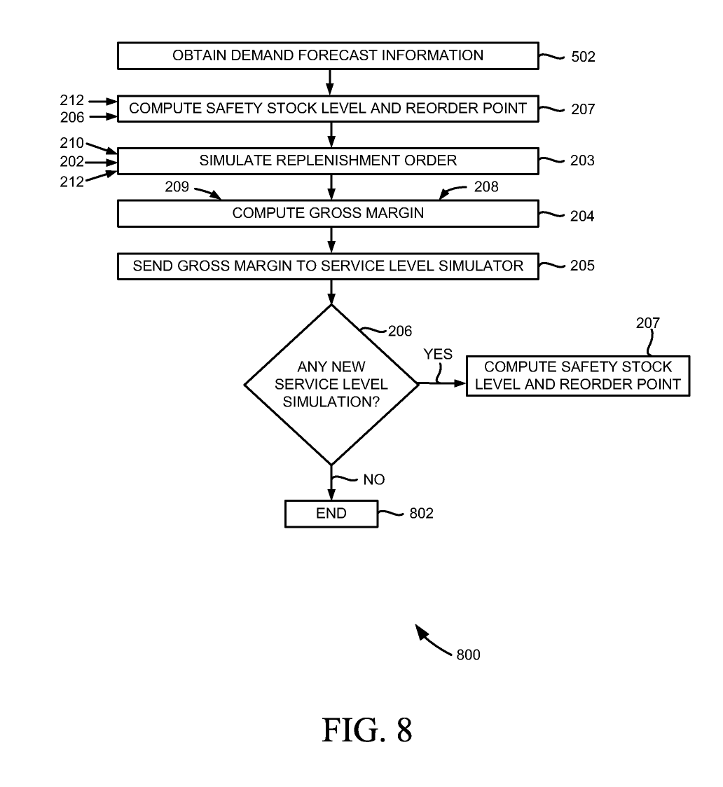

Referring now to FIG. 8, another flowchart 800 illustrates a method, according to an embodiment of the invention. At block 502, the demand forecast information is obtained. This is explained in more detail with reference to the block 502 in FIG. 6. At block 207, the safety stock level and the reorder point is computed. This is explained in detail with reference to the block 207 in FIG. 2. In this embodiment, the safety stock level and the reorder point are computed based on the supplier lead time information obtained as explained in detail with reference to the block 212 in FIG. 7 and the output of the block 206 as explained in detail with reference to the block 206 in FIG. 2.

At block 203, the replenishment order is simulated. In this embodiment, the replenishment order is computed based parameters, such as the lost demand computed as explained in detail with reference to the block 202 in FIG. 2, the EOQ computed as explained in detail with reference to the block 210 in FIG. 5 and a supplier lead time information obtained as explained in detail with reference to the block 212 in FIG. 7. Furthermore, the computation of the replenishment order using the equations (2) to (6) are explained in more detail with reference to the block 203 in FIG. 2. At block 204, the gross margin is computed. This is explained in more detail with reference to the block 204 in FIG. 2.

At block 205, the computed gross margin is sent to the service level simulator. This is explained in more detail with reference to the block 205 in FIG. 2. At block 206, it is determined whether there is any new customer service level to be simulated. This is explained in more detail with reference to the block 206 in FIG. 2. Further, if there is a new customer service level, the safety stock level and the reorder point is computed at the block 207. Furthermore, the computation of the safety stock level and the reorder point using the equations (9) and (10) are explained in more detail with reference to the block 207 in FIG. 2. In addition, if there is no new customer service level to be simulated, the process ends at block 802.

Referring now to FIG. 9, a block diagram illustrates merchandise inventory management system, according to an embodiment of the invention and an environment in which methods, such as those shown in FIG. 1 can operate. Particularly, the block diagram illustrates an inventory management module 900. As shown in FIG. 9, the inventory management module 900 includes an order management system 902, a service level simulator 904, a safety stock calculator 906, a demand forecast system 908, a supplier management system 910, a replenishment simulator 912, an EOQ calculator 914, a financial system 916, a markdown analyzer 918, a sales database 920, a lost sales estimator 922 and a metrics evaluator 924.

In operation, the inventory management module 900 is configured to model the inventory to maximize the gross margin as a function of replenishment of merchandise that is based on the optimum customer service level. Further in operation, the inventory management module 900 is configured to model the inventory to maximize the gross margin as a function of the replenishment of merchandise that is based on the optimum customer service level including assumed values for at least the inventory carrying costs, the lost sales costs and the markdown costs. In addition in operation, the inventory management module 900 is configured to model the inventory to maximize the gross margin as a function of the replenishment for each item in each location based on the optimum customer service level.

Further in operation, the service level simulator 904 is configured to determine a desired customer service level range 928 for each item in each location based on parameters, such as the sales history, the EOQ, the markdown information and the forecasted future demand. In addition, the EOQ is obtained from an actual order 926, as shown in FIG. 9. The actual order 926 is obtained from the order management system 902, as shown in FIG. 9. Also, the service level simulator 904 simulates the impact of each customer service level in the determined customer service level range 928 for each item in each location based on metrics of business objective 954, as shown in FIG. 9.

Furthermore in operation, the safety stock calculator 906 is configured to compute a safety stock level 932 for each item in each location for each customer service level in the determined customer service level range 928 using supplier lead time information 934 and a forecast future demand 930. In this embodiment, the supplier lead time information 934 is obtained from the supplier management system 910 and the forecast future demand 930 is obtained from the demand forecast system 908, as shown in FIG. 9.

Further in this embodiment, the safety stock calculator 906 determines the optimum customer service level for each item in each location based on the computed gross margin for each item in each location in the determined customer service level range 928 to maximize the gross margin. Furthermore in this embodiment, the safety stock calculator 906 determines a required inventory level for each item in each location based on the determined optimum customer service level, order lead time, delivery schedule, demand pattern, and the computed replenishment order quantity to maximize the gross margin.

In addition in operation, the replenishment simulator 912 is configured to compute the replenishment quantity 946 for each item in each location for each customer service level in the determined customer service level range 928 based on the computed safety stock level 932, the forecast demand pattern, and the EOQ 938, a lost demand 948 and markdown 944. Further in this embodiment, the EOQ 938 is obtained from the EOQ calculator 914, the markdown 944 is obtained from the markdown analyzer 918 and the lost demand 948 is obtained from the lost sales estimator 922.

Furthermore in this embodiment, the EOQ calculator 914 computes the EOQ 938 based on a forecast annual demand 936 and a cost data 940. The forecast annual demand 936 is obtained from the demand forecast system 908 and the cost data 940 is obtained from the financial system 916. In addition in this embodiment, markdown analyzer 918 analyzes the demand patterns based on planned markdown activities for a given SKU at a given location. This enables the markdown analyzer 918 to simulate the resulting demand based on the markdown price. The information thus obtained is sent to the replenishment simulator 912 to analyze the impact of markdown on the available inventory. Also in this embodiment, lost sales estimator 922 captures the lost demand 948 based on sales data 950 obtained from the sales database 920.

Moreover in this embodiment, the replenishment simulator 912 tracks the units of inventory sold, monitor the inbound shipments and update the end of day inventory. Based on the updated end of day inventory information, a decision is made to make an order or not on the current day. In addition in this embodiment, the quantity of order to be made is also computed.

Also in operation, the metrics evaluator 924 is configured to compute the gross margin for each item in each location for each customer service level in the determined customer service level range 928 based on the computed replenishment quantity 946, lost sales, the inventory carrying costs, markdown schedule and other financial information 952. Also, the metrics evaluator 924 evaluates the financial impact of each customer service level in the determined customer service level range 928.

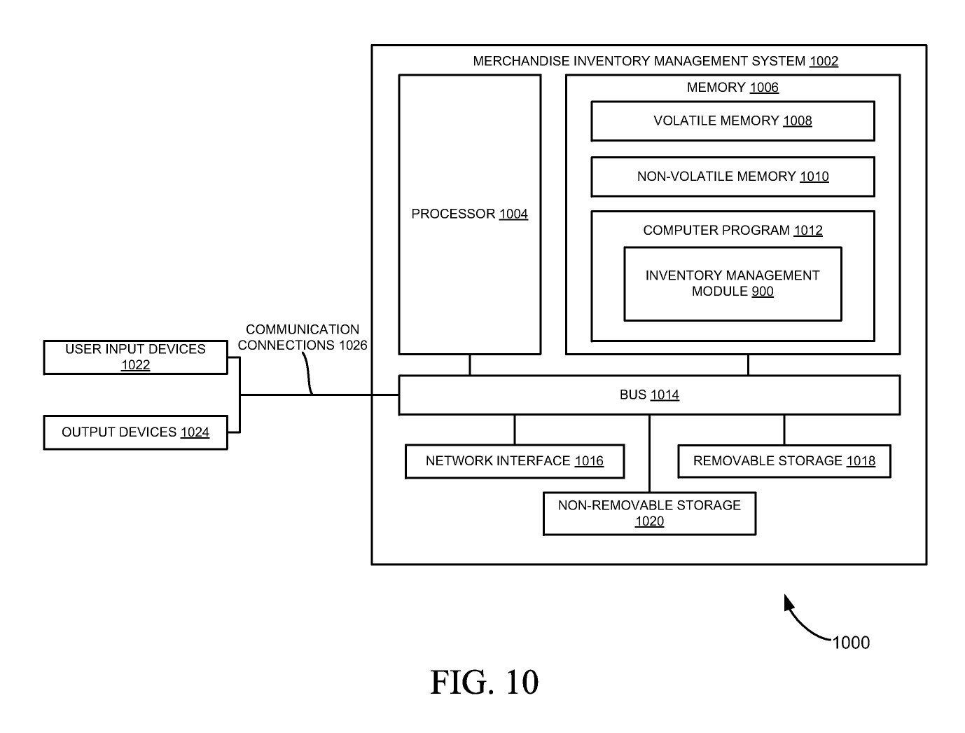

Referring now to FIG. 10, which illustrates a block diagram 1000 of a data processing system in which any of the embodiments disclosed herein may be performed, according to an embodiment of the invention. FIG. 10 and the following discussions are intended to provide a brief, general description of a suitable computing environment in which certain embodiments of the inventive concepts contained herein are implemented.

The merchandise inventory management system 1002 includes a processor 1004, memory 1006, a removable storage 1018, and a non-removable storage 1020. The merchandise inventory management system 1002 additionally includes a bus 1014 and a network interface 1016. As shown in FIG. 10, the merchandise inventory management system 1002 includes access to the computing system environment 1000 that includes one or more user input devices 1022, one or more output devices 1024, and one or more communication connections 1026 such as a network interface card and/or a universal serial bus connection.

Exemplary user input devices 1022 include a digitizer screen, a stylus, a trackball, a keyboard, a keypad, a mouse and the like. Exemplary output devices 1024 include a display unit of the personal computer, a mobile device and the like. Exemplary communication connections 1026 include a local area network, a wide area network, and/or other network.

The memory 1006 further includes volatile memory 1008 and non-volatile memory 1010. A variety of computer-readable storage media are stored in and accessed from the memory elements of the merchandise inventory management system 1002, such as the volatile memory 1008 and the non-volatile memory 1010, the removable storage 1018 and the non-removable storage 1020. The memory elements include any suitable memory device(s) for storing data and machine-readable instructions, such as read only memory, random access memory, erasable programmable read only memory, electrically erasable programmable read only memory, hard drive, removable media drive for handling compact disks, digital video disks, diskettes, magnetic tape cartridges, memory cards, Memory Sticks™, and the like.

The processor 1004, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processor 1004 also includes embedded controllers, such as generic or programmable logic devices or arrays, application specific integrated circuits, single-chip computers, smart cards, and the like.

Embodiments of the present subject matter may be implemented in conjunction with program modules, including functions, procedures, data structures, and application programs, for performing tasks, or defining abstract data types or low-level hardware contexts. Machine-readable instructions stored on any of the above-mentioned storage media may be executable by the processor 1004 of the merchandise inventory management system 1002. For example, a computer program 1012 includes machine-readable instructions capable of providing merchandise inventory management to maximize gross margin in the merchandise inventory management system 1002, according to the teachings and herein described embodiments of the present subject matter. In one embodiment, the computer program 1012 is included on a compact disk-read only memory (CD-ROM) and loaded from the CD-ROM to a hard drive in the non-volatile memory 1010. The machine-readable instructions cause the merchandise inventory management system 1002 to encode according to the various embodiments of the present subject matter.

As shown, the computer program 1012 includes the inventory management module 900. For example, the inventory management module 900 can be in the form of instructions stored on a non-transitory computer-readable storage medium. The non-transitory computer-readable storage medium having the instructions that, when executed by the merchandise inventory management system 1002, causes the merchandise inventory management system 1002 to perform the one or more methods described in FIGS. 1 through 9.

In various embodiments, the above-described methods and systems of FIGS. 1 through 10 enable determining an optimal service level for an individual business objective or a combined composite business objective. Further, the above mentioned embodiments enable incorporation of markdown cost, inventory cost and lost cost while determining the optimal service level to optimize the gross margin.

Although, the present embodiments have been described with reference to specific example embodiments, it will be evident that various modifications and changes may be made to these embodiments without departing from the broader spirit and scope of the various embodiments. Furthermore, the various devices, modules, analyzers, generators, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

What is claimed is:

1. A computer-implemented method for merchandise inventory management to maximize gross margin, comprising:
modeling inventory to maximize gross margin as a function of replenishment of merchandise that is based on optimum customer service level.

2. The computer-implemented method of claim 1, wherein modeling the inventory to maximize gross margin as a function of the replenishment of merchandise that is based on the optimum customer service level comprising assumed values for at least inventory carrying costs, lost sales costs and markdown costs.

3. The computer-implemented method of claim 2, wherein modeling the inventory to maximize gross margin as a function of the replenishment of merchandise comprises:
modeling the inventory to maximize gross margin as a function of the replenishment for each item in each location based on the optimum customer service level.

4. The computer-implemented method of claim 3, wherein modeling the inventory to maximize gross margin as a function of the replenishment of each item in each location based on the optimum customer service level, comprises:
determining a desired customer service level range for each item in each location based on parameters selected from the group consisting of sales history, economic order quantity, markdown information and forecasted future demand;
computing a safety stock level for each item in each location for each customer service level in the determined customer service level range using, supplier lead time information, and the forecasted future demand;
computing a replenishment quantity for each item in each location for each customer service level in the determined customer service level range based on the computed safety stock level, the forecast demand pattern, and the economic order quantity; and
computing a gross margin for each item in each location for each customer service level in the determined customer service level range based on the computed replenishment quantity, lost sales, the inventory carrying costs, markdown schedule, and other financial information.

5. The computer-implemented method of claim 4, further comprising:
determining an optimum customer service level for each item in each location based on the computed gross margin for each item in each location in the determined customer service level range to maximize the gross margin.

6. The computer-implemented method of claim 5, further comprising:
determining a required inventory level for each item in each location based on the determined optimum customer service level and demand pattern to maximize the gross margin.

7. The computer-implemented method of claim 6, further comprising:
determining a required inventory level for each item in each location based on the determined optimum customer service level and parameters selected from the group consisting of order lead time, delivery schedule, demand pattern, and the computed replenishment order quantity.

8. A non-transitory computer-readable storage medium for merchandise inventory management to maximize gross margin has instructions that, when executed by a computing device cause the computing device to perform a method comprising:
modeling inventory to maximize gross margin as a function of replenishment of merchandise that is based on optimum customer service level.

9. The non-transitory computer-readable storage medium of claim 8, wherein modeling the inventory to maximize gross margin as a function of the replenishment of merchandise that is based on the optimum customer service level comprising assumed values for at least inventory carrying costs, lost sales costs and markdown costs.

10. The non-transitory computer-readable storage medium of claim 9, wherein modeling the inventory to maximize gross margin as a function of the replenishment of merchandise comprises:
modeling the inventory to maximize gross margin as a function of the replenishment for each item in each location based on the optimum customer service level.

11. The non-transitory computer-readable storage medium of claim 10, wherein modeling the inventory to maximize gross margin as a function of the replenishment of each item in each location based on the optimum customer service level, comprises:
determining a desired customer service level range for each item in each location based on parameters selected from the group consisting of sales history, economic order quantity, markdown information and forecasted future demand;
computing a safety stock level for each item in each location for each customer service level in the determined customer service level range using supplier lead time information, and the forecasted future demand;
computing a replenishment quantity for each item in each location for each customer service level in the determined customer service level range based on the computed safety stock level, the forecast demand pattern, and the economic order quantity; and
computing a gross margin for each item in each location for each customer service level in the determined customer service level range based on the computed replenishment quantity, lost sales, the inventory carrying costs, markdown schedule, and other financial information.

12. The non-transitory computer-readable storage medium of claim 11, further comprising:
determining an optimum customer service level for each item in each location based on the computed gross margin for each item in each location in the determined customer service level range to maximize the gross margin.

13. The non-transitory computer-readable storage medium of claim 12, further comprising:
determining a required inventory level for each item in each location based on the determined optimum customer service level and demand pattern to maximize the gross margin.

14. The non-transitory computer-readable storage medium of claim 13, further comprising:
determining a required inventory level for each item in each location based on the determined optimum customer service level and parameters selected from the group consisting of order lead time, delivery schedule, demand pattern, and the computed replenishment order quantity.

15. A system for merchandise inventory management system to maximize gross margin, comprising:
a processor; and
memory coupled to the processor, wherein the memory includes an inventory management module having instructions to:
model inventory to maximize gross margin as a function of replenishment of merchandise that is based on optimum customer service level.

16. The system of claim 15, wherein the inventory management module further having instruction to:
model the inventory to maximize gross margin as a function of the replenishment of merchandise that is based on the optimum customer service level comprising assumed values for at least inventory carrying costs, lost sales costs and markdown costs.

17. The system of claim 16, wherein the inventory management module further having instructions to:
model the inventory to maximize gross margin as a function of the replenishment for each item in each location based on the optimum customer service level.

18. The system of claim 17, wherein the inventory management module further having instructions to:
determine a desired customer service level range for each item in each location based on parameters selected from the group consisting of sales history, economic order quantity, markdown information and forecasted future demand;
compute a safety stock level for each item in each location for each customer service level in the determined customer service level range using supplier lead time information and the forecasted future demand;
compute a replenishment quantity for each item in each location for each customer service level in the determined customer service level range based on the computed safety stock level, the forecast demand pattern and the economic order quantity; and
compute a gross margin for each item in each location for each customer service level in the determined customer service level range based on the computed replenishment quantity, lost sales, the inventory carrying costs, markdown schedule, and other financial information.

19. The system of claim 18, wherein the inventory management module further having instruction to:
determine an optimum customer service level for each item in each location based on the computed gross margin for each item in each location in the determined customer service level range to maximize the gross margin.

20. The system of claim 19, wherein the inventory management module further having instructions to:
determine a required inventory level for each item in each location based on the determined optimum customer service level and demand pattern to maximize the gross margin.

21. The system of claim 20, wherein the inventory management module further having instructions to:
determine a required inventory level for each item in each location based on the determined optimum customer service level and parameters selected from the group consisting of order lead time, delivery schedule, demand pattern and the computed replenishment order quantity.

22. A system for merchandise inventory management system to maximize gross margin, comprising:
an inventory management module configured to model inventory to maximize gross margin as a function of replenishment of merchandise that is based on optimum customer service level.

23. The system of claim 22, wherein the inventory management module is further configured to model the inventory to maximize gross margin as a function of the replenishment of merchandise that is based on the optimum customer service level comprising assumed values for at least inventory carrying costs, lost sales costs and markdown costs.

24. The system of claim 23, wherein the inventory management module is further configured to model the inventory to maximize gross margin as a function of the replenishment for each item in each location based on the optimum customer service level.

25. The system of claim 24, wherein the inventory management module comprises:
a service level simulator configured to determine a desired customer service level range for each item in each location based on parameters selected from the group consisting of sales history, economic order quantity, markdown information and forecasted future demand;
a safety stock calculator configured to compute a safety stock level for each item in each location for each customer service level in the determined customer service level range using supplier lead time information and the forecasted future demand;
a replenishment simulator configured to compute a replenishment quantity for each item in each location for each customer service level in the determined customer service level range based on the computed safety stock level, the forecast demand pattern and the economic order quantity; and
a metrics evaluator configured to compute a gross margin for each item in each location for each customer service level in the determined customer service level range based on the computed replenishment quantity, lost sales, the inventory carrying costs, markdown schedule and other financial information.

26. The system of claim 25, wherein the safety stock calculator determines an optimum customer service level for each item in each location based on the computed gross margin for each item in each location in the determined customer service level range to maximize the gross margin.

27. The system of claim 26, wherein the safety stock calculator determines a required inventory level for each item in each location based on the determined optimum customer service level and demand pattern to maximize the gross margin.

28. The system of claim 27, wherein the safety stock calculator determines a required inventory level for each item in each location based on the determined optimum customer service level and parameters selected from the group consisting of order lead time, delivery schedule, demand pattern, and the computed replenishment order quantity.
